(19) United States
(12) Patent Application Publication
(10) Pub. No.: US 2026/0112827 A1
(43) Pub. Date: Apr. 23, 2026

(54) CARD EDGE CONNECTOR

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: KUO-CHUN HSU, New Taipei (TW); XUN WU, Huaian (CN); YAN ZHENG, Huaian (CN); XIAO-HU YIN, Huaian (CN)

(21) Appl. No.: 19/365,692

(22) Filed: Oct. 22, 2025

(30) Foreign Application Priority Data
Oct. 22, 2024 (CN) 202422549454.6

(51) Int. Cl. H01R 12/70; H01R 12/72

(52) U.S. Cl. CPC H01R 12/7052; H01R 12/721

(57) ABSTRACT

A card edge connector includes: a base having a card slot for a card to be inserted; a lever spring rotatably connected to the base; an ear latch rotatably connected to a first end of the base and to a first arm of the spring lever; a contact member slidably connected to the base; and a drive member connected to the contact member and a second arm of the spring lever, wherein: a spacer block is disposed in the card slot for slidable connection by the contact member, a contact region is formed between a second end of the base and the spacer block, the contact member has a force-bearing block extending into the contact region, and a face of the spacer block facing the contact region has a clearance opening; and the force-bearing block is configured to abut a portion of the card inserted into the contact region, and the clearance opening allows the portion of the card inserted into the contact region to move in a direction toward the spacer block.

### BACKGROUND OF THE INVENTION

### Field of the Invention

The present disclosure relates to a connector, particularly to a card edge connector.

### Description of Related Arts

Currently, many motherboards of computers are equipped with a card edge connector, which allows for plugging in cards such as graphics cards and memory sticks to expand the functionality of the computer. A card edge connector typically includes a base, a latch, a contact mechanism, and a lever spring. The base has a slot for plugging in the card. The middle portion of the lever spring is pivotally connected to the base via a hinge. The latch is connected to a first arm of the lever spring and is rotatably connected to the base. The latch can be switched between an open position and a closed position through rotation. The contact mechanism is connected to a second arm of the lever spring and slides within the slot.

When a card is inserted into the slot, the card presses down on the contact mechanism and the second arm of the lever spring, causing the lever spring to deform and store energy, allowing the latch to rotate to the closed position. To remove the card from the slot, the user applies force to the end of the card away from the ear latch, thus releasing the contact mechanism, and the lever spring releases energy to recover its shape. The first arm of the lever spring moves and pushes the ear latch to automatically rotate to the open position, unlocking the card.

However, in practice, users may apply force to the end of the card closer to the ear clip. This can easily damage and deform the base near the contact mechanism, affecting proper movement of the contact mechanism and creating an uneven unlocking process and jamming.

### SUMMARY OF THE INVENTION

A card edge connector comprises: a base having a card slot for a card to be inserted; a lever spring rotatably connected to the base; an ear latch rotatably connected to a first end of the base and to a first arm of the spring lever; a contact member slidably connected to the base; and a drive member connected to the contact member and a second arm of the spring lever, wherein: a spacer block is disposed in the card slot for slidable connection by the contact member, a contact region is formed between a second end of the base and the spacer block, the contact member has a force-bearing block extending into the contact region, and a face of the spacer block facing the contact region has a clearance opening; and the force-bearing block is configured to abut a portion of the card inserted into the contact region, and the clearance opening allows the portion of the card inserted into the contact region to move in a direction toward the spacer block.

### BRIEF DESCRIPTION OF DRAWINGS

FIG. 1 shows changing states of a card edge connector in the related art, wherein the ear latch of the card edge connector changes from an open state to a closed state;

FIG. 2 shows a schematic view of the state of a card being removed normally from the base;

FIG. 3 shows a schematic view of the state of the card being removed from the base in the reverse direction;

FIG. 4 is a schematic diagram of a card edge connector and a card provided by the present disclosure;

FIG. 5 is a schematic diagram of the card edge connector provided by the present disclosure having an ear latch at an open position;

FIG. 6 is a schematic diagram of the card edge connector provided by the present disclosure having the ear latch at the closed position;

FIG. 7 is a cross-sectional view of the card edge connector of FIG. 6;

FIG. 8 is an enlarged view of portion A of FIG. 7;

FIG. 9 is a schematic diagram of a top face of the second end of the base according to the present disclosure;

FIG. 10 is a schematic diagram of the bottom face of the second end of the base provided herein;

FIG. 11 is a schematic diagram of the second end of the base according to the present disclosure;

FIG. 12 is a cross-sectional view of the second end of the base in FIG. 11; and

FIG. 13 is a schematic diagram of the contact member and the drive member according to the present disclosure.

### DETAILED DESCRIPTION OF THE DRAWINGS

In the description of the embodiments of this disclosure, technical terms such as “first” and “second” are used solely to distinguish between different elements and should not be construed as indicating or implying relative importance or implicitly specifying the quantity, specific order, or primary/secondary relationship of the indicated technical features.

In the present disclosure, unless otherwise expressly specified or defined, terms such as “connected,” “disposed,” and “fixed” should be interpreted broadly, such as fixed connections, detachable connections, or integral connections; or direct connections, indirect connections through an intermediate medium, or fluid communications between two components. Persons skilled in the art will understand the specific meanings of these terms in this application based on the specific situations.

Unless otherwise defined, all technical and scientific terms used in the present disclosure have the same meanings as commonly understood by persons skilled in the art. The terms used in the present disclosure are for the purpose of describing specific embodiments only and are not intended to limit the present disclosure. The terms “including,” “having,” and any variations thereof in the specification and claims of the present disclosure and the accompanying drawings are intended to cover non-exclusive inclusions.

References herein to “embodiments” refer to the specific features, structures, or characteristics described in connection with the embodiments may be included in at least one embodiment of the present disclosure. The usage of this phrase in various parts in the present disclosure does not necessarily refer to the same embodiment, nor does it constitute an independent or alternative embodiment that is mutually exclusive of other embodiments. It is understood, both explicitly and implicitly, that the embodiments described herein may be combined with other embodiments.

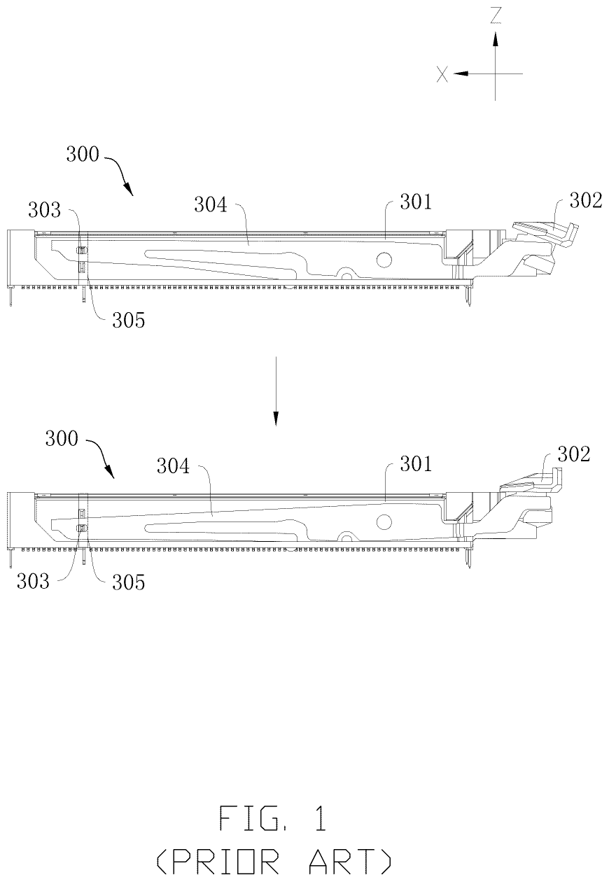

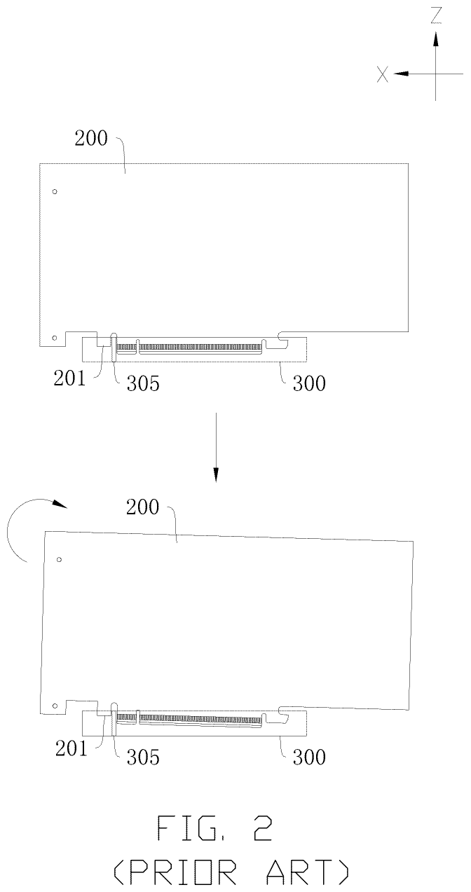

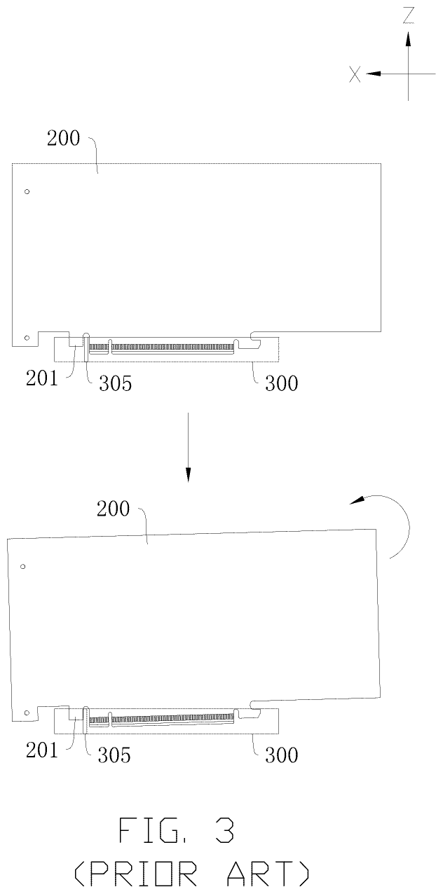

FIG. 1 shows changing states of a card edge connector in the related art, wherein the ear latch of the card edge connector changes from an open state to a closed state. FIG. 2 shows a schematic view of the state of a card being removed normally from the base. FIG. 3 shows a schematic view of the state of the card being removed from the base in the reverse direction.

As shown in FIG. 1 to FIG. 3, a card edge connector 300 in the related art generally includes a base 301, an ear latch 302, a contact drive mechanism 303, and a lever spring 304. The base 301 is provided with a slot for inserting the card 200, and a spacer block 305 is disposed in the slot. The middle portion of the lever spring 304 is rotatably connected to the base 301 via a shaft. The ear latch 302 is connected to the first arm of the lever spring 304, and the ear latch 302 is rotatably connected to the base 301. The ear latch 302 can be switched between an open state and a closed state by rotation. The contact drive mechanism 303 is connected to the second arm of the lever spring 304 and slides onto the spacer block 305 in the base 301.

The card 200 has a first insertion portion 201, which is positioned corresponding to the contact drive mechanism 303.

When the card 200 is inserted into the base 301, the first insertion portion 201 of the card 200 presses down on the contact drive mechanism 303, which in turn drives downward a second arm of the lever spring 304. The spacer block 305 enters the notch, the lever spring 304 deforms and stores energy, and the ear latch 302 rotates to the closed state. The card 200 establishes an electrical connection with the card edge connector via the conductive contacts of the second insertion portion 202.

To normally pull the card 200 out of the base 301, the user needs to first apply force to the end of the card 200 close to the first insertion portion 201 to slightly pull out the first insertion portion 201 of the card 200. Namely, the end of the card 200 proximal to the first insertion portion 201 is first pulled out from the base 301 at an angle. During this process, the first insertion portion 201 of the card 200 releases the contact drive mechanism 303, and at the same time, the lever spring 304 releases energy and returns to original shape, and the first arm of the lever spring 304 moves and pushes the ear latch 302 to automatically rotate to the open state, thereby achieving automatic unlocking. Then, the card 200 is pulled out of the base 301 as a whole, and the card 200 can now be unlocked and pulled out smoothly.

However, when removing the card 200 in practice, the user might directly apply force to the end of the card 200 distal from the first insertion portion 201, causing the card 200 to be pulled out from the base 301 in the opposite direction. When the card 200 is pulled out from the base 301 in the opposite direction, the end of the card 200 distal from the first insertion portion 201 is first pulled out of the base 301 at an angle. At this time, the first insertion portion 201 of the card 200 moves toward the spacer block 305 and abuts against the spacer block 305. Given that the spacer 305 is located at the end of the card 200 and the overall rotation and tilting of the card 200 creates a lever, even if the user applies a small force to the end of the card 200 distal from the first insertion portion 201, the pressure exerted by the first insertion portion 201 on the spacer 305 is effectively amplified by the lever, potentially causing severe compression of the spacer block 305, resulting in damage and deformation. This can affect the normal movement of the contact drive mechanism 303 during the subsequent unlocking operation, resulting in an unsmooth unlocking or even a jam.

Thus, an embodiment of the present disclosure provides a card edge connector that achieves the technical benefits of smooth unlocking and prevents jamming.

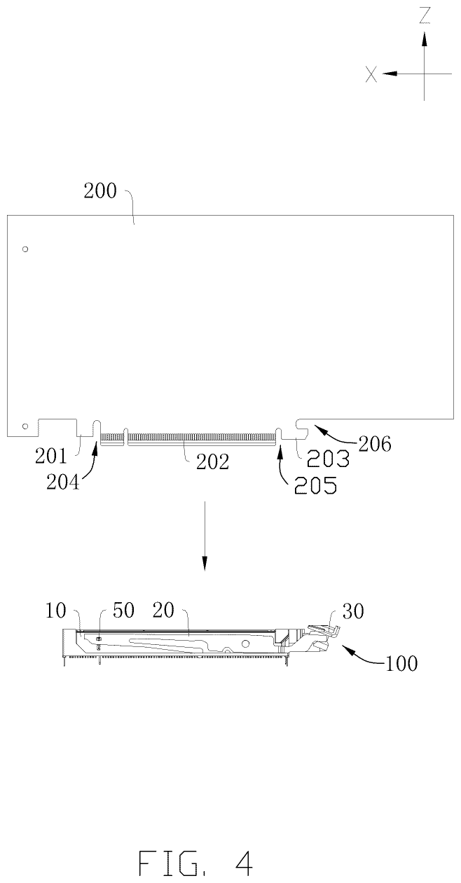

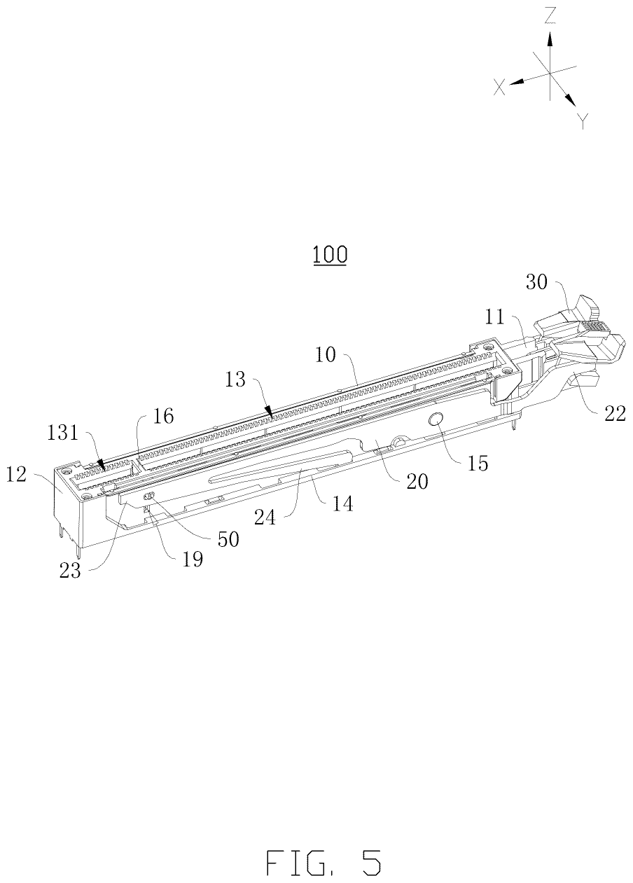

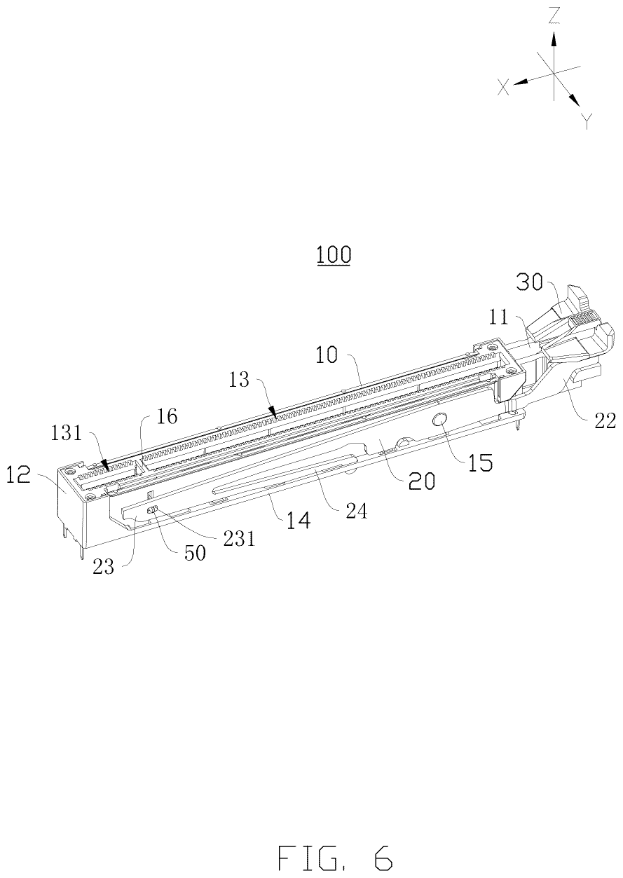

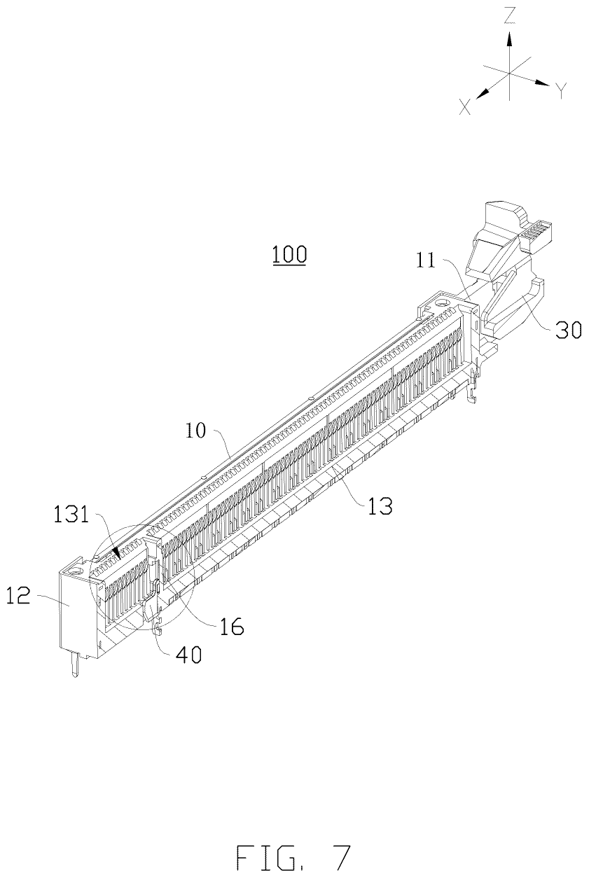

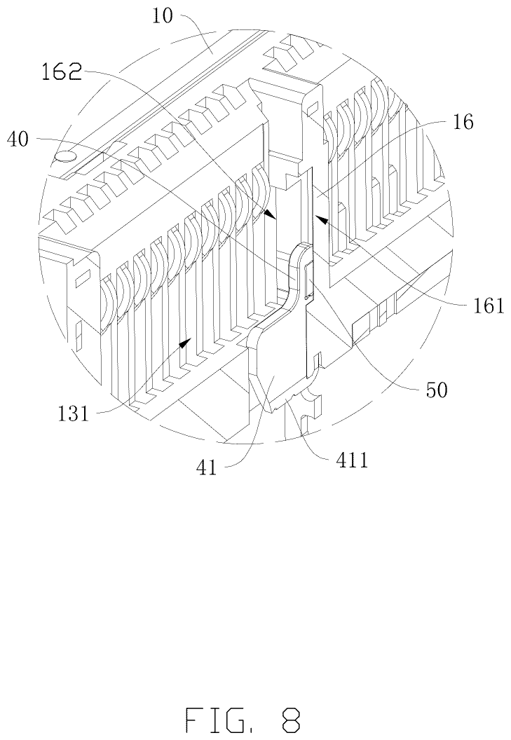

FIG. 4 is a schematic diagram of a card edge connector and a card provided by the present disclosure. FIG. 5 is a schematic diagram of the card edge connector provided by the present disclosure having an ear latch at an open position. FIG. 6 is a schematic diagram of the card edge connector provided by the present disclosure having the ear latch at the closed position. FIG. 7 is a cross-sectional view of the card edge connector of FIG. 6. FIG. 8 is an enlarged view of portion A of FIG. 7.

As shown in FIG. 4 to FIG. 8, the card edge connector 100 can be used in computer devices. Specifically, the card edge connector 100 can be installed on the motherboard of the computer device, and a card 200 can be inserted into the card edge connector 100 to electrically connect the card 200 to the motherboard, thereby expanding the functionality of the computer device.

In this embodiment, the card edge connector 100 can be a PCI-e connector, and the card 200 can be a graphics card. The card 200 has a first insertion portion 201, a second insertion portion 202, and a third insertion portion 203. The first insertion portion 201 and the second insertion portion 202 are separated by a first notch 204, and the second insertion portion 202 and the third insertion portion 203 are separated by a second notch 205. The second insertion portion 202 has conductive contacts, and the edge of the third insertion portion 203 is provided with a fixing notch 206.

As shown in FIGS. 1, 3, and 4, the card edge connector 100 includes a base 10, a lever spring 20, an ear latch 30, a contact member 40, and a drive member 50. The base 10 is generally elongated, having a first end 11 and a second end 12 formed at two ends in the length-wise direction. The length of the base 10 is shown by the X-axis shown in the figure.

The base 10 has a slot 13 passing through a top face of the base 10 to form a notch for receiving a card 200. Specifically, the slot 13 accommodates the first insertion portion 201, the second insertion portion 202, and the third insertion portion 203 of the card 200. The insertion and removal direction of the card 200 is shown by the Z-axis shown in the figure. A protruding edge 14 is formed on the side of the base 10, extending along the length-wise direction of the base 10.

The lever spring 20 is rotatably connected to the base 10. Specifically, a rotation hole is provided in the middle of the lever spring 20, and a rotation shaft 15 is formed on the side of the base 10. The lever spring 20 is rotatably connected to the rotation shaft 15 through the rotation hole. The lever spring 20 has a first arm 22 and a second arm 23. The first arm 22 is located corresponding to the first end 11 of the base 10, and the second arm 23 is located corresponding to the second end 12 of the base 10. The second arm 23 has a drive hole 231. The lever spring 20 also has a resilient arm 24. One end of the resilient arm 24 is connected to the second arm 23 of the lever spring 20. The other end of the resilient arm 24 is spaced apart from the second arm 23 of the lever spring 20 and abuts the protruding edge 14. A quantity of the lever springs 20 is, for example, two. The two lever springs 20 are respectively disposed at two sides of the base 10.

An ear latch 30 is rotatably connected to the first end 11 of the base 10. The ear latch 30 can be switched between an open state and a closed state by rotation. The ear latch 30 is connected to the first arm 22 of the lever spring 20. When the first arm 22 of the lever spring 20 moves, the first arm 22 drives the ear latch 30 to rotate.

In some embodiments of the present disclosure, the ear latch 30 operates as follows: when the ear latch 30 rotates away from the base 10, the ear latch 30 is in an open position, allowing the third insertion portion 203 to be inserted into one end of the slot 13.

When the ear latch 30 rotates toward the base 10, the ear latch 30 blocks one end of the slot 13 and is at a closed position, the third insertion portion 203 is inserted into one end of the slot 13, and the built-in stopper of the ear latch 30 enters the fixing notch 206 of the third insertion portion 203. Thus, the ear latch 30 restricts the third insertion portion 203 in the slot 13, preventing the card 200 from being removed from the base 10.

The contact member 40 is positioned in the slot 13 and is slidably connected to the base 10. The sliding direction of the contact member 40 is parallel to the insertion and removal direction of the card 200. Specifically, the slot 13 includes a spacer block 16 for the contact member 40 to slidably engage. The spacer block 16 is integrally formed with the base 10, and a gap between the second end 12 of the base 10 and the spacer block 16 form a contact region 131. The contact member 40 has a force-bearing block 41 that extends into the contact region 131. The force-bearing block 41 is used to press against the portion of the card 200 inserted into the contact region 131. A clearance opening 162 is provided on the side of the spacer block 16 facing the contact region 131. This clearance opening 162 allows the portion of the card 200 inserted into the contact region 131 to move toward the spacer block 16.

The drive member 50 is connected between the contact member 40 and the second arm 23 of the lever spring 20. When the contact member 40 moves, the drive member 50 moves synchronously with the contact member 40, driving the second arm 23 of the lever spring 20 to move. Specifically, an end of the drive member 50 is inserted into the drive hole 231 of the second arm 23. When the drive member 50 moves, the drive member 50 abuts an inner side of the drive hole 231, driving the second arm 23 to move.

In some embodiments of the present disclosure, the contact member 40, the drive member 50, the lever spring 20, and the ear latch 30 operate as follows. When the contact member 40 is pressed downward, the contact member 40 moves in a first direction, and through the drive member 50 drives the second arm 23 of the lever spring 20 to move in the first direction, such that the lever spring 20 rotates in a positive direction, pressing the second arm 23 downward and lifting the first arm 22. At this time, bending deformation occurs between the resilient arm 24 and the second arm 23. The first direction is the negative direction of the Z axis in the figure.

When the contact member 40 is not being pressed downward, the resilient arm 24 and the second arm 23 regain their shape. The resilient arm 24 abuts the protruding edge 14, causing the second arm 23 to rise, the first arm 22 to press downward, and the lever spring 20 to rotate in the opposite direction. At this point, the first arm 22 drives the ear latch 30 from the closed position to the open position, while the second arm 23, via the drive member 50, drives the contact member 40 in the second direction. The second direction is shown as the positive direction of the Z axis.

As can be understood, when the card 200 is inserted into the card slot 13, the first insertion portion 201 of the card 200 enters the contact region 131, pressing the contact member 40 downward. The contact member 40 then drives the second arm 23 of the lever spring 20 downward, causing the spacer block 16 to enter the first notch 204. The lever spring 20 deforms, storing energy, and the ear latch 30 can rotate to the closed position.

To remove the card 200, the user can first apply force to the end of the card 200 proximal to the first insertion portion 201, slightly withdrawing the first insertion portion 201, allowing the end of the card 200 proximal to the first insertion portion 201 to removed from the contact area 131 at an inclined angle. During this process, the first insertion portion 201 releases the contact member 40, and the lever spring 20 releases energy and recovers in shape. The first arm 22 of the lever spring 20 moves and pushes the ear latch 30 to automatically rotate to the open position, achieving automatic unlocking. The card 200 can then be completely removed from the card slot 13. The card 200 can now be smoothly unlocked and removed.

When the card 200 is removed from the slot 13 in the reverse direction, namely, when the user directly applies force to the end of the card 200 distal from the first insertion portion 201, the end of the card 200 distal from the first insertion portion 201 is first pulled away from the slot 13 at an angle. At this point, the first insertion portion 201 of the card 200 moves toward the spacer block 16 and into the clearance opening 162, weakening the pressure of the first insertion portion 201 on the side of the spacer block 16, reducing damage or deformation to the spacer block 16 and ensuring smooth sliding of the contact member 40, thereby ensuring a smooth unlocking action.

Of note, when the card 200 is removed from the slot 13 in the reverse direction, the ear latch 30 does not automatically rotate to the open position. The user can manually rotate the ear latch 30 to unlock and remove the card 200 from the slot 13.

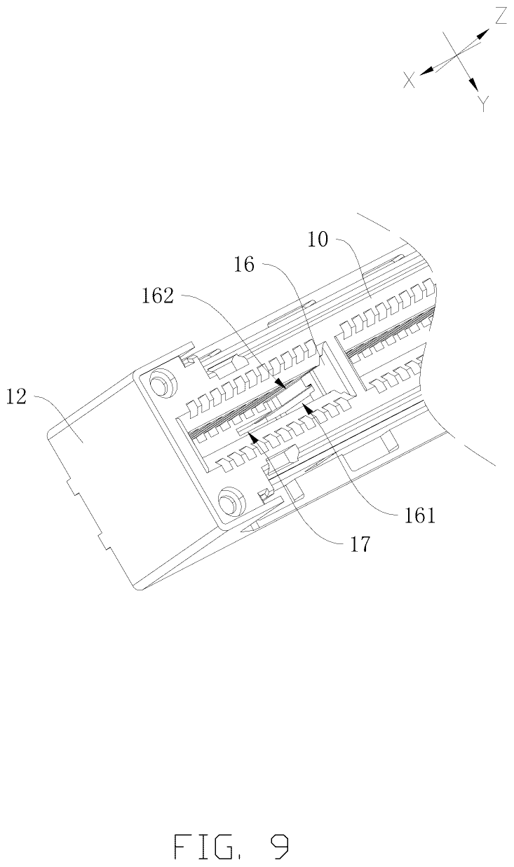

FIG. 9 is a schematic diagram of a top face of the second end 12 of the base 10 according to the present disclosure.

As shown in FIGS. 4, 7, 8, and 9, in some embodiments, the spacer block 16 has a sliding groove 161. The sliding groove 161 is located on the side of the spacer block 16 facing the contact region 131. The sliding groove 161 extends along the insertion and removal direction of the card 200. The sliding groove 161 is connected to the clearance opening 162, which connects two opposite sides of the sliding groove 161. The contact member 40 is partially accommodated in and slidably connected to the sliding groove 161. In this way, the sliding groove 161 restricts the sliding movement of the contact member 40, ensuring that the contact member 40 slides in a specified direction. Furthermore, the sliding groove 161 restricts the sliding movement of the contact member 40, preventing the contact member 40 from moving excessively.

In some embodiments, the width of the clearance opening 162 is greater than or equal to the thickness of the card 200. The width of the clearance opening 162 (i.e., the thickness of the card 200) is shown in the Y-axis in the figure. For example, the width of the clearance opening 162 is slightly greater than the thickness of the card 200. Thus, when the card 200 is removed from the slot 13 in the reverse direction, the first insertion portion 201 of the card 200 can move directly into the clearance opening 162, reducing direct contact between the first insertion portion 201 and the spacer 16 block, thereby reducing the compression force.

In some embodiments of the present disclosure, the thickness of the first insertion portion 201 of the card 200 can be 1.57 mm, and the width of the clearance opening 162 can be 1.75 mm. In other embodiments, the type of card 200 can be configured according to actual needs, and the thickness of the card 200 can be adjusted accordingly, and the width of the clearance opening 162 can be adaptively adjusted, not being limited by the present disclosure.

In some embodiments, a positioning opening 17 is provided at the bottom of the slot 13. The positioning opening 17 is in fluid communication with the sliding slot 161. The force-bearing block 41 is at least partially accommodated in the positioning opening 17.

When the force-bearing block 41 is pressed against the first insertion portion 201 of the board 200, the force-bearing block 41 completely enters the positioning opening 17. The positioning opening 17 not only reduces the internal space occupied by the force-bearing block 41 in the contact region 131, but also serves to position the force-bearing block 41, ensuring that the force-bearing block 41 can be lifted upward after the first insertion portion 201 is withdrawn.

When the force-bearing block 41 is in a natural state, namely when the force-bearing block 41 is not pressed against the first insertion portion 201 of the card 200, the lower portion of the force-bearing block 41 is contained within the positioning opening 17, and the upper portion of the force-bearing block 41 is exposed by the positioning opening 17 and enters the contact region 131. The positioning opening 17 positions the lower portion of the force-bearing block 41, ensuring that the force-bearing block 41 completely enters the positioning opening 17 when pressed downward, preventing the force-bearing block 41 from shifting.

In some embodiments, the force-bearing block 41 has a tapered portion 411 at a side facing away from the slot 13. The width of the tapered portion 411 gradually decreases as it moves away from the slot 13. For example, the tapered portion 411 is located at the bottom of the force-bearing block 41, and both sides of the tapered portion 411 gradually become closer further away from the slot 13. When the force-bearing block 41 is in the natural state, the tapered portion 411 of the force-bearing block 41 is accommodated in the positioning opening 17. When the force-bearing block 41 is pressed against the first insertion portion 201 of the card 200, the tapered portion 411 facilitates the entry of the force-bearing block 41 into the positioning opening 17, preventing any jamming between the force-bearing block 41 and the positioning opening 17.

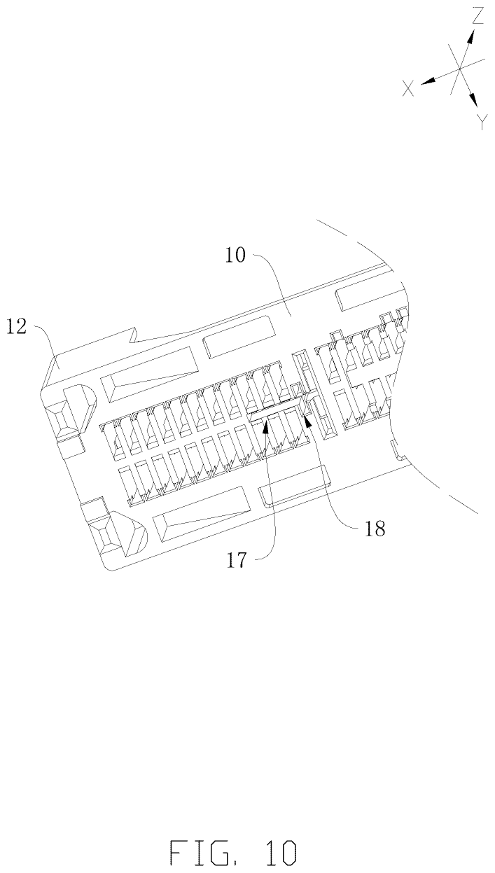

FIG. 10 is a schematic diagram of the bottom face of the second end 12 of the base 10 provided herein.

As shown in FIGS. 7, 9, and 10, in some embodiments, a cutout opening 18 is provided on the side of the base 10 facing away from the notch of the card slot 13. The position of the cutout 18 corresponds to the clearance opening 162, and the cutout opening 18 is in fluid communication with the clearance opening 162. For example, the cutout opening 18 is located at the bottom face of the base 10, and the projection of the clearance opening 162 in the height direction of the base 10 overlaps the cutout opening 18. The height direction of the base 10 is shown by the Z-axis in the figures.

It is understood that during the molding process of the base 10, after the base 10 is formed by injection molding, a sliding groove 161 can be first formed on a side of the spacer block 16 of the base 10. Then, based on the shape of the cutout opening 18, a cutout can be made upward along the height direction of the base 10 to create a certain space in the base 10 to form the clearance opening 162. This simplifies the molding process and improves production efficiency.

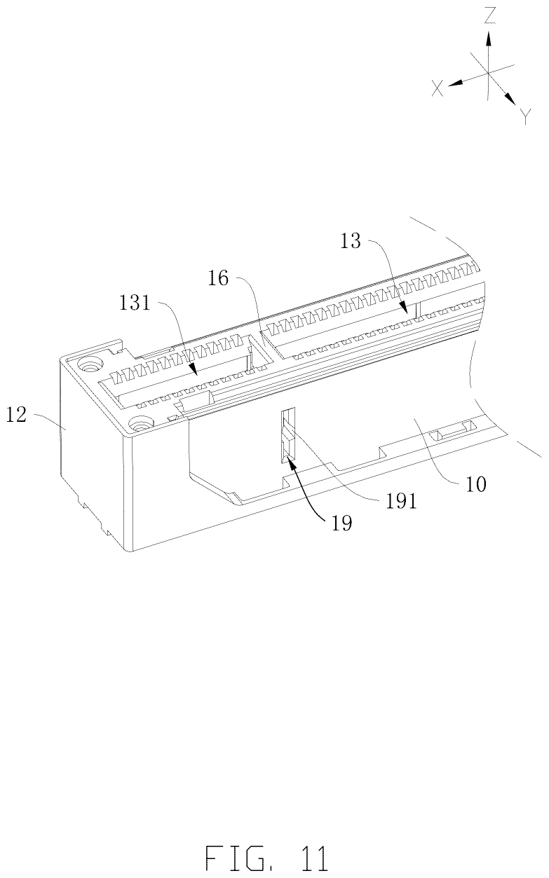

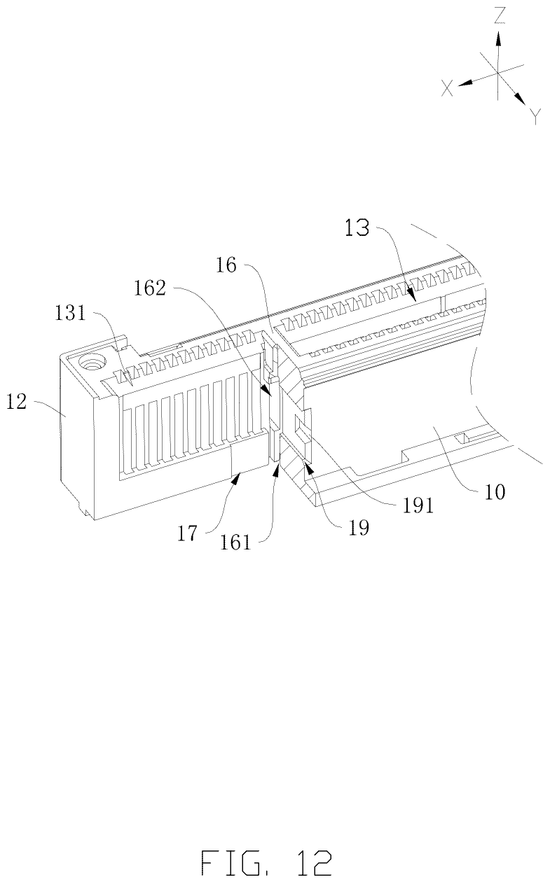

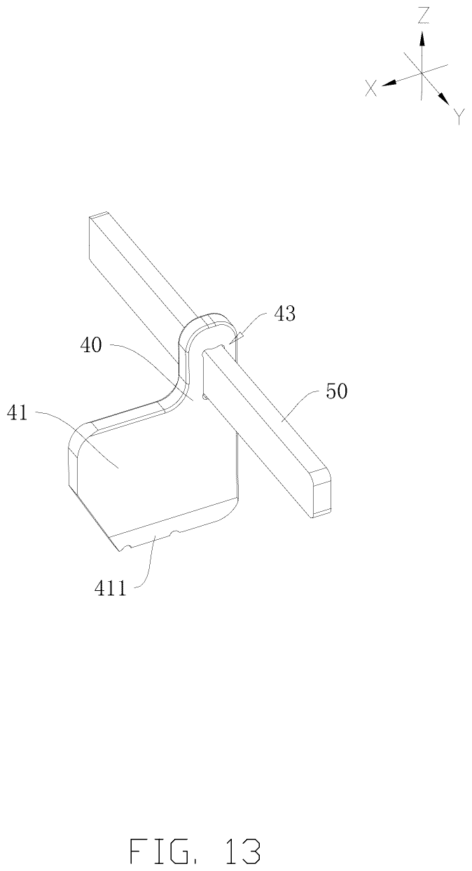

FIG. 11 is a schematic diagram of the second end 12 of the base 10 according to the present disclosure. FIG. 12 is a cross-sectional view of the second end 12 of the base 10 in FIG. 11. FIG. 13 is a schematic diagram of the contact member 40 and the drive member 50 according to the present disclosure.

As shown in FIGS. 6, 11, 12, and 13, in some embodiments, the base 10 has a restricting slot 19. The restricting slot 19 is parallel to the sliding slot 161, is in fluid communication with the card slot 13, and passes through the side of the base 10. The restricting slot 19 engages the drive member 50. The drive member passes through the restricting slot 19 and connects to the second arm 23 of the lever spring 20. The restricting slot 19 passes through opposite sides of the base 10, allowing two ends of the drive member 50 to respectively pass through neighboring restricting slots 19, and connecting the two lever springs 20 on two sides of the base 10.

In this way, when the contact member 40 moves, the drive member 50 slides in the restricting slot 19, preventing the drive member 50 from deviating in position and ensuring that the drive member 50 can smoothly drive the second arm 23 of the lever spring 20. Furthermore, the restricting slot 19 limits the sliding movement of the drive member 50, preventing the drive member 50 from excessive movement.

In some embodiments, a widening portion 191 is provided in the middle of the retaining slot 19. The side walls of the widening portion 191 are recessed, such that the retaining slot 19 has narrower ends and a wider middle portion. It is understood that during the molding process of the base 10, the shape of the retaining slot 19 is determined by the shape of the mol. By configuring the retaining slot 19 to be narrower at the ends and wider at the center, the mold is prevented from being too slender and susceptible to damage, thereby strengthening the mold and improving production efficiency.

In some embodiments, the contact member 40 is generally L-shaped. The upper end of the contact member 40 is connected to the drive member 50, and the lower end of the contact member 40 protrudes to form a force-bearing block 41. Specifically, a portion of the upper end of the contact member 40 is received in the sliding groove 161, and the other portion is exposed outside the sliding groove 161 and is provided with a mounting hole 43. The mounting hole 43 is positioned corresponding to the retaining slot 19, and a projection of the mounting hole 43 along the width of the base 10 overlaps the retaining slot 19. The width direction of the base 10 is shown by the Y-axis in the figure.

In some embodiments, the drive member 50 is generally in the shape of an elongated plate. The length of the drive member 50 is parallel to the width of the base 10. The drive member 50 is inserted into the mounting hole 43 and passes through the retaining slot 19. Specifically, the middle portion of the drive member 50 is inserted into the mounting hole 43, and the ends of the linkage 50 are respectively inserted into adjacent retaining slots 19.

In this way, the restricting slots 19 on both sides of the base 10 can each restrict the drive member 50, improving the smoothness of the movement of the drive member 50 and preventing damage caused by unbalanced force on one end of the drive member 50.

In some embodiments, the inner side of the mounting hole 43 is formed with multiple protrusions, which abut the drive member 50, thereby securing the drive member 50 to the contact member 40 through friction. In this way, the drive member 50 can be fixed to the contact member 40 through an insertion connection, facilitating assembly and disassembly of the connecting member 50 and the contact member 40, thereby improving production efficiency.

Finally, it should be noted that the above embodiments are intended only to illustrate the technical solutions of this application and are not limited thereto. Although the present disclosure has been described in detail with reference to preferred embodiments, those skilled in the art will appreciate that modifications or equivalent substitutions may be made to the technical solutions of the present disclosure without departing from the spirit and scope of the technical solutions of the present disclosure.

1. A card edge connector comprising:
a base having a card slot for a card to be inserted;
a lever spring rotatably connected to the base;
an ear latch rotatably connected to a first end of the base and to a first arm of the spring lever;
a contact member slidably connected to the base; and
a drive member connected to the contact member and a second arm of the spring lever; wherein
a spacer block is disposed in the card slot for slidable connection by the contact member, a contact region is formed between a second end of the base and the spacer block, the contact member has a force-bearing block extending into the contact region, and a face of the spacer block facing the contact region has a clearance opening; and
the force-bearing block is configured to abut a portion of the card inserted into the contact region, and the clearance opening allows the portion of the card inserted into the contact region to move in a direction toward the spacer block.

2. The card edge connector according to claim 1, a width of the clearance opening is greater than or equal to a thickness of the card.

3. The card edge connector according to claim 1, wherein the spacer block has a sliding slot extending in an insertion direction of the card, the sliding slot is in fluid communication with the clearance opening, and the contact member is partially accommodated in and slidably connected to the sliding slot.

4. The card edge connector according to claim 3, wherein a bottom of the card slot has a positioning opening in fluid communication with the sliding slot, and the force-bearing block is partially accommodated in the positioning opening.

5. The card edge connector according to claim 4, wherein a side of the force-bearing block distal from an opening of the card slot has a tapered portion, and widths of the tapered portion gradually decreases further away from the opening of the card slot.

6. The card edge connector according to claim 3, wherein the base has a restricting slot arranged parallel to the sliding slot, the restricting slot is in fluid communication with the card slot, the restricting slot passes through a side of the base, and the drive member passes through the restricting slot and is connected to a second arm of the lever spring.

7. The card edge connector according to claim 6, wherein a portion of the contact member exposed by the sliding slot has a mounting hole a position of the mounting hole corresponds to a position of the restricting slot, and the drive member is inserted in the mounting hole and passes through the restricting slot.

8. The card edge connector according to claim 7, wherein the restricting slot passes through opposite two sides of the base, the mounting hole is arranged at a middle portion of the drive member, and one end of the drive member passes through the restricting slot.

9. The card edge connector according to claim 6, wherein a middle portion of the restricting slot has a widening portion, and two side walls of the widening portion are recessed.

10. The card edge connector according to claim 1, wherein a face of the base distal from an opening of the card slot has a cutout opening, a position of the cutout opening corresponds to a position of the clearance opening, and the cutout opening is in fluid communication with the clearance opening.
